(19) United States
(12) Patent Application Publication
(10) Pub. No.: US 2015/0367305 A1
(43) Pub. Date: Dec. 24, 2015

(54) HIGH PRESSURE PARTICLE INJECTOR

(71) Applicants: John Sheneman, Dallas, TX (US); John Vuksich, Palacios, TX (US)

(72) Inventors: John Sheneman, Dallas, TX (US); John Vuksich, Palacios, TX (US)

(21) Appl. No.: 14/744,622

(22) Filed: Jun. 19, 2015

Related U.S. Application Data
(60) Provisional application No. 61/998,148, filed on Jun. 20, 2014.

(51) Int. Cl. B01F 15/02; E21B 7/18; B01F 5/04; E21B 43/267

(52) U.S. Cl. CPC B01F 15/0227; E21B 43/267; E21B 7/18; B01F 5/04; B01F 2215/0081

(57) ABSTRACT

A combination of hard particles and a fluid may be created by a vessel which stores the hard particles and receives a first flow of fluid via a first fluid interface source. A mixing block receives the hard particles, the first flow of fluid and a second flow of fluid and combines the first flow of fluid, the second flow of fluid and the hard particles and provides a combined flow of fluid to an external source.

### CROSS-REFERENCE TO RELATED APPLICATIONS

This application claims priority to earlier filed provisional application No. 61/998,148 filed on Jun. 20, 2014 and entitled “HIGH PRESSURE SOLID PARTICLE INJECTOR”, the entire contents of which are hereby incorporated by reference.

### TECHNICAL FIELD OF THE APPLICATION

This application relates to a high pressure particle injector and more particularly to a dynamic and variable configuration of injecting solid particles into a fluid.

### BACKGROUND OF THE APPLICATION

Conventionally, water or similar fluid compositions may be used to perform drilling and may also be used for other industrial purposes. In one conventional example, water or other fluids must be pumped at a high pressure into a drilling location to excavate and soften the ground of the earth for mining oil or other deep ground resources. The solution used to soften the earth may be pumped at a high rate of exchange and may include various minerals or hard objects intended to loosen cracks and provide access to oil.

Hydraulic fracturing may be used to include the propagation of fractures in a rock layer, as a result of the action of a pressurized fluid. Some hydraulic fractures form veins or dikes, and can create conduits along which gas and petroleum from source rocks may migrate to reservoir rocks. Induced hydraulic fracturing or ‘hydrofracking’, commonly known as ‘fraccing’ or ‘fracking’, is a technique used to release petroleum, natural gas (including shale gas, tight gas and coal seam gas), or other substances for extraction. This type of fracturing creates fractures from a wellbore drilled into reservoir rock formations.

Additionally, the production of hydrocarbons miles below the earth's surface presents various challenges one of which is a lack of permeability in the rock. Although oil and gas wells may be drilled into a reserve of hydrocarbons, without permeability, fluid flow of the hydrocarbons may be minimal, effectively rendering the well economically useless. To increase the fluid flow (flow rate), the permeability of the rock must be altered. One method to increase permeability is hydraulic fracturing. As stated above, hydraulic fracturing is a process of pumping water at a high pressure into a rock formation to create cracks that allow hydrocarbons to flow through those cracks.

Once the pumping pressure is removed, the cracks that were created can close, and the fluid flow returns to the low rate. Often sand will be added to the fracing water so when pumping pressure is removed, sand remains in the cracks and keeps them from closing. The result is a more permanent increase in hydrocarbon flow. Current methods for pumping ‘frac’ water involve the use of high-pressure pumps. High fluid pressures are required for two reasons. First, to break rock requires a great amount of force which means high fluid pressures are required. Second, the fluid pressure must overcome the inherent pressures found in hydrocarbon wells which can be several thousand pounds per square inch.

To achieve these pumping pressure positive displacement pumps, utilizing large plungers inside of a chamber, are used to move sand and water. However, the design of these pumps requires precision internal seals and valves. In a traditional ‘frac’ job, the positive displacement pump may be required to run for extended periods of time, exposing the components of the pump to the harsh abrasives, i.e. sand, and chemicals that the ‘frac’ fluid contains. Periodically, the pump needs to be shutdown and cleaned to remove solids from the seat and valve, or new valves and seals must be installed. In addition, just as the sand holds open rock formations, the sand inside a pump can hold open valves, thus limiting the size of solids that a positive displacement pump can move into the ground. Finally, when pumping a slurry solution, the concentration of the solids in the fluid is constrained by the pump. Moreover, displacement pumps are often broken during fracing operations.

### SUMMARY OF THE APPLICATION

One example embodiment may provide an apparatus that includes at least one of a vessel which stores a plurality of hard particles and receives a first flow of fluid, a first fluid interface source that provides the first flow of fluid into the vessel at a first controllable flow rate, a mixing block which receives the hard particles, the first flow of fluid and a second flow of fluid, a second fluid interface source that provides the second flow of fluid into the mixing block at a second controllable flow rate, and an output interface which combines the first flow of fluid, the second flow of fluid and the hard particles and provides a combined flow of fluid to an external source.

Another example embodiment may include a method that includes at least one of providing a first flow of fluid to a vessel storing a plurality of hard particles at a first controllable flow rate, ejecting the hard particles into a mixing block which receives the hard particles, the first flow of fluid and a second flow of fluid, providing the second flow of fluid into the mixing block at a second controllable flow rate, combining the first flow of fluid, the second flow of fluid and the hard particles to create a combined flow of fluid provided to an external source.

Yet another example embodiment includes a vessel which stores a plurality of hard particles and is pressurized via a fluid injected into the vessel, a mixing block comprising a channel for the fluid to pass and an auger which rotates inside the mixing block permitting the hard particles to move out of the vessel and into the mixing block and an output interface which combines the fluid and the hard particles and provides a combined flow of fluid to an external source.

### BRIEF DESCRIPTION OF THE DRAWINGS:

FIG. 1 illustrates an example of a particle injection device according to example embodiments.

FIG. 2A illustrates an example of the fluid and particle combining channels of the mixer block according to example embodiments.

FIG. 2B illustrates an example of the fluid and particle combining channels of the mixer block according to example embodiments.

FIG. 3 illustrates a flow diagram of an example method of operation according to example embodiments.

FIG. 4 illustrates another flow diagram of an example method of operation according to example embodiments.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

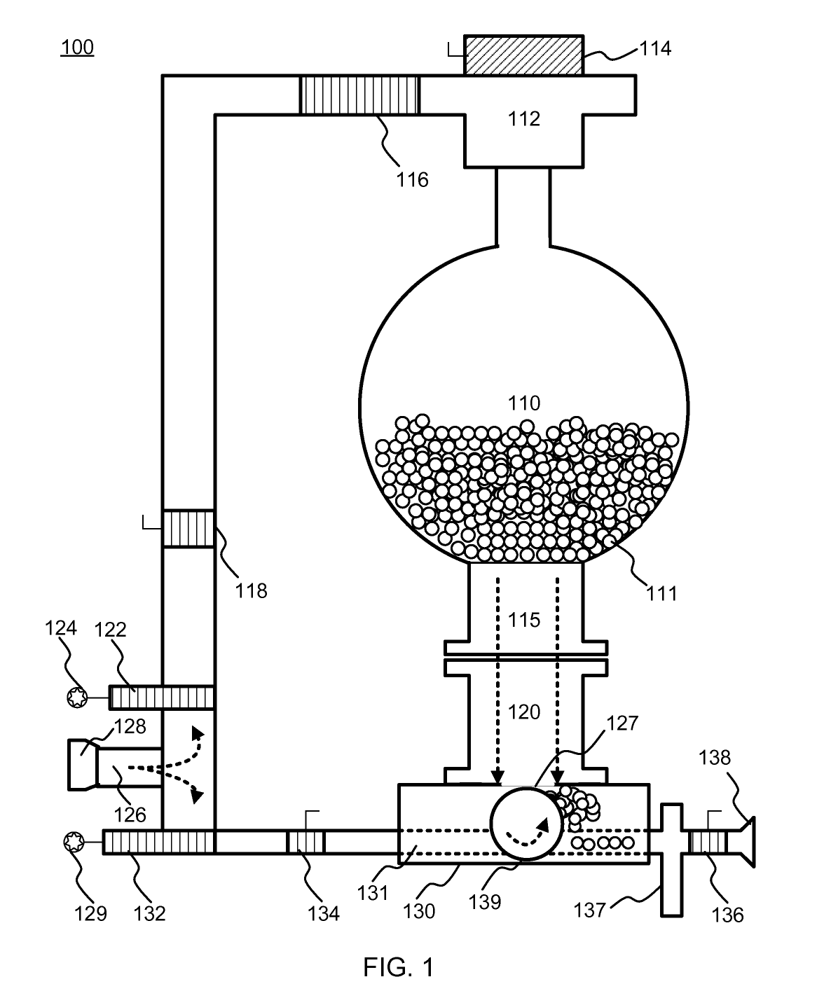

FIG. 1 illustrates an example particle injection device according to example embodiments. Referring to FIG. 1, the injection device 100 includes various components used to create a high-pressure particle injection coupled to a mixing block and fluid feed which outputs to an output interface 138 which feeds the mixed fluid to an exit pip used to move the mixed fluid to a desired location. The pressure is generally realized from a fluid source 128, which may be a high-pressure water interface that provides water to a vessel 110 and to a mixing block 130. Two separate adjustable chokes including valves 124 and 129 and pipe inputs 122 and 132 provide a way to adjust the pressure of the vessel 110 and the rate of exchange of the fluid 126 presented to the mixer block 130 and the vessel 110 from the fluid interface 128. Additionally, ball valves 118 and 134 may be a combination of full port and/or reduced port valves used to adjust fluid input rates. The corner of the fluid medium may be a 90 degree elbow part (not shown) attached to a union pipe (not shown) which attaches to a coupling 116 contiguous with the 4-way connector 112. Atop the 4-way connector 112 is a large full port ball valve, such as a 3-inch ball valve 114 used to permit the large particles to be introduced into the vessel 110.

Beneath the vessel 110 full of particles 111 is a 2500 spool flange 115 which is laid contiguous with a 1500/2500 spool flange 120 which is laid contiguous with the mixing block 130. In operation, as the pressure builds in the vessel from the fluid input from the flow of fluid into the vessel, the particles 111 will be moved downward into the mixing block 130. The quantity of particles per gallon of fluid may be adjusted by the pressure of the vessel and the flow rate of fluid into the mixing chamber. A dump 137 is conveniently located near the output of the chamber 130 and a ball valve 136 provides an adjustable option for permitting the fluid to pass from the mixer to an external location via output interface 138. The passing hole or receiving passage 127 permits the particles to be passed from the vessel 110 to the mixing chamber 130.

One example method of operation may include injecting a variable concentration of solid particles into a high-pressure fluid stream to be carried downhole in a hydrocarbon production well. An operating cycle may include loading solid particles into a high pressure vessel through an inlet, filling the pressure vessel with fluid, sealing the vessel, setting the chokes to keep the pressure vessel full of fluid during injection, establishing a fluid flow through the various portions of the system, including both the high pressure vessel 110 as well as through the mixing block 130, engaging the auger 139 at a determined rate per minute or gallons per minute (RPM) to move solids into the flow path of the fluid.

With regard to fracing technology, certain results have yielded an increase in the production of energy. One experimental technique involves the use of a gel as the fracing fluid, such as a rich viscus type fluid as replacement to sand and with a proppet of a more specific geometric structure (i.e. spheres, cornered cubes, etc.), and the deliberate targeting of the rock formation in the earth to be modified. This approach requires that solid particles 111 of approximately ¼ inch diameter be forced into the hydrocarbon well. Once inside the well, the geothermal heat and pressure from the pressure insertion transforms the particles into a fracing gel and proppet combination. The traditional pumps used for pumping slurry cannot pass such large solids, much less provide the desired solid-to-water concentration.

Example embodiments provide an efficient approach for introducing harsh, solid particles into a high-pressure fluid stream at a variable solid concentration. With such a method, the harsh, solid particles do not pass through the pump thus avoiding the limitations imposed by a pump. The high-pressure vessel 110 stores the solid particles and provide them to the mixing block 130. The mixing block contains an auger for the controlled metering of solid particles and an inlet for a high pressure carrying fluid (e.g., water, kerosene, fluid nitrogen, air, etc.) coming from a positive displacement pump. The use of the pressure vessel 110 for the solid particles and the mixing block 130 removes the requirement for the pumps to pass solids as the pumps are able to pump clean fluid before the injection. Both the auger's speed delivering the solid particles and the flow rate of the carrying fluid are controllable which permits for an instantaneous variation of both a mixed density of fluid-to-solids as well as the total flow of fluid. The technique also permits the use of chemically reactive carrying fluids and particles to achieve specific effects when pumped within the well.

As the solid particles 110 are introduced into the fluid stream, the volume of the solids within the pressure vessel decreases. This decrease is compensated so backflow will not occur in the auger 139. The high-pressure vessel 110 includes a line-in for fluid flow to replace the volume of the exiting particles. The carrying fluid flow goes through two adjustable chokes 124 and 126 to vary the amount of fluid that goes into the pressure vessel and through the mixing block 130. Once the flow is split by the chokes, a portion is directed through a vertical pipe above the vessel 110. The remainder of the flow is sent directly through the mixing block 130 and into the well. The chokes should be set to permit the maximum fluid flow through the mixing block 130 while preventing backflow through the auger channel.

Before establishing fluid flow, the pressure vessel 110 is filled with the solids 111 to be introduced into the well. In the immediate application, the particles will be in the pressure vessel 110 with water and will pass through the water onto the auger, thus the particles must have a specific gravity greater than one. The use of other fluids and particles must be matched so the particles do not “float” away from the auger. Once the particles are loaded into the pressure vessel 110, the pressure vessel is filled with water. To fill the vessel, water may be passed through the top of the tank where the particles 11 are loaded, or water may be pumped in through a separate line-in, and closing the valve on the downstream side of the mixing block, the flow can be directed into the tank.

Once the vessel is loaded with solids and filled with water, the speed of the auger is adjusted to achieve the desired solid concentration. Auger displacement is an important consideration driven by the requirements of flow rate, particle size and concentration. Displacement of an auger varies by pitch, thickness, spacing of the blades, as well as the root thickness of the auger shaft. This specific design permits for the easy replacement of augers of different displacement as well as the re-sleeving of the auger channel to permit for smaller diameter augers.

The mixing block begins its service function as a solid block of steel. While excessive in material, the advantages include the ease of fabrication as only simple machining operations are employed, such as ease of the attachment of the pressure vessel, ease of attachment of the device that turns the auger, ruggedness, and strength for safety necessary in high pressure operation. The injection of small particles of material for various purposes is a common practice in the wells of an oilfield. Common uses include proppant in hydraulic fracturing, fluid-loss additives in drilling, and, more recently, small particles of degradable polymer for fluid diversion. Such practices are performed using commonly-found equipment designed to move not only fluids, but particles suspended in the fluids, such as an everpresent triplex pump. However, such equipment is limited in its ability to displace larger particles greater than 6 or 8 mesh.

Example embodiments overcome conventional limitations of existing oilfield equipment and offers additional features, such as eliminating the need for a blender and a chemical suspension package and offering the injection of multi-barrel volumes “on-the-fly” without passing through a pump. Pumping any size particles through a triplex pump has inherent drawbacks, such as wear on the internal components of the pump, and pumping large particles through a triplex pump is not feasible. The particles can get stuck inside the pump and inhibit an effective seal to generate the desired rate and pressure. Injecting particles with a triplex pump also requires the creation of a slurry with suspended particles prior to displacement through the pump. This suspension can require the addition of chemical additives to modify a viscosity of the fluid to support such particles which increases the complexity of any procedure calling for the injection of particles.

The novel equipment developed for the injection of particles relies on certain components to accomplish its purpose, such as a high-pressure material storage vessel 110 and an injection block 130. The high pressure storage vessel has a capacity for 105 gallons of material and can be filled with material through an opening 112 at the top of the vessel. A platform around the vessel permits for safe and easy access to the filling port and a typical procedure calls for the loading of material to the platform via a forklift. The material loaded into the vessel can be of any diameter 1/16, 1/12, ⅛, ¼, ⅓, etc. and up to one inch and can be comprised of virtually any solid material.

The second component of the equipment is the high-pressure injection block. Fluid is passed through this component at pressures up to 3,000 PSI which is also the pressure rating on the entire unit, and at rates up to 5 BPM. The injection block is attached to the storage vessel and meters particles into the fluid stream at variable and predictable rates. Testing of the equipment has yielded injection rates as low as 2% solids concentration by volume and as high as 25% solids concentration by volume. Since the mixing of the fluid and the injected particles happens “on-the-fly” no chemical additives were needed to inject particles that would have normally required heavy viscosity modifiers to inject.

The procedure for performing this novel particle injection process was performed with a triplex pump and water truck in combination with the particle injector. The triplex pump was configured to pull fluid from the water truck and pump it toward the wellbore. In between the triplex pump and the wellbore, the particle injector was installed in-line with an additional “bypass” line installed to permit fluid to move into the wellbore without passing through the injection block. The installation of the equipment is similar to a “ball injector” used for placing ball sealers into a wellbore, but this equipment is both more versatile in permitting for a wide range of particle sizes and also capable of injecting at greater volumes.

Applications for this equipment are still being explored. It was initially created to facilitate a proprietary “SqueezeFrac” process, but it may have additional applications in the oilfield or in pumping and injection purposes, such as cleaning a large pipe in any application. For instance, the equipment could be used to inject very large quantities of ball sealers or large particles for fluid diversion, to inject small quantities of proppant for hydraulic fracturing in a simplified low-cost process, or other applications where the injection of larger-diameter particles may be beneficial.

Five field trials of the equipment have been performed with successful results. Particle injection was accomplished at fluid rates of 1-2 BPM and 10-15% particle concentration by volume at pressures up to 2,900 PSI. Additional applications for the equipment are being considered, and the procedure to apply the device to the oilfield is being refined to further enhance the device's effectiveness and reliability.

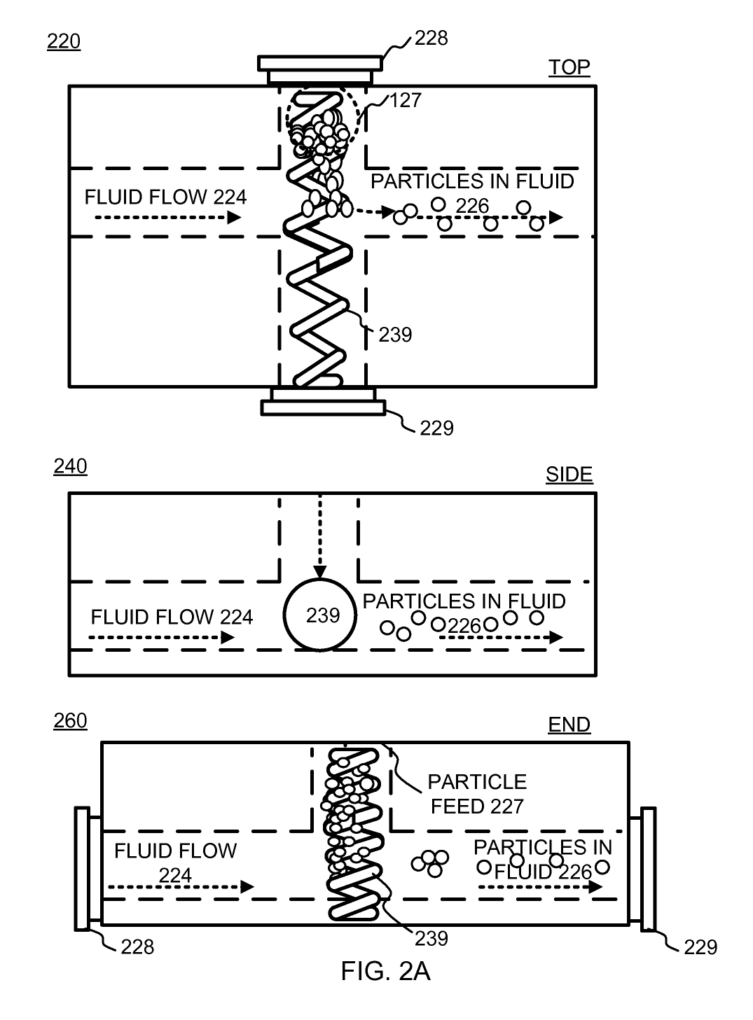

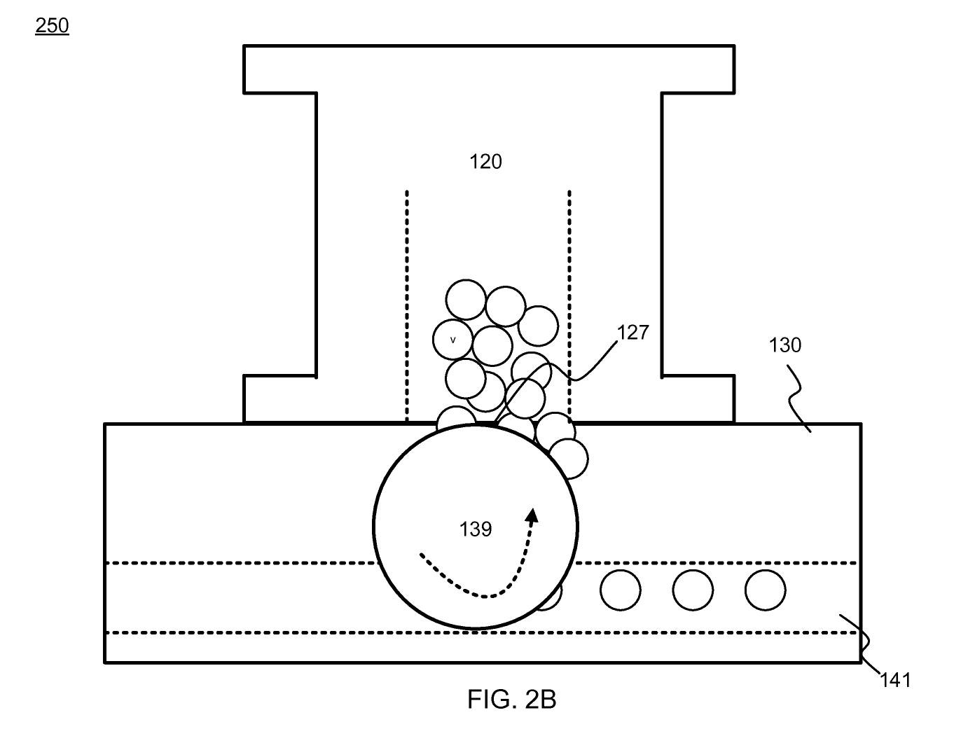

FIG. 2A illustrates example fluid flow scenarios according to example embodiments. Referring to FIG. 2A, a solid block of material is selected for ease of manufacturing of the mixing chamber 220 for strength under pressure and for versatility. The machining process is essentially a well understood process of drilling two large passageways through the block as may be appreciated by one skilled in the art. The excess material permits for both strength and the availability of area “real-estate” to attach connectors and motors as required.

The top perspective of the mixing block 220 or 130 includes a fluid flow pattern 224 that passes alongside the auger 239 which is setup to rotate via an external hydraulic or electric-powered motor. The auger 239 rotates to permit the solid particles to pass with the fluid 226 at a desired density rate. The faster the auger turns and rotates the more solid particles can be moved from the bottom of the high pressure vessel 110 to the output of the chamber 220. Similarly, in side perspective 240, the back of the auger 239 is illustrated as a cylindrical compartment that turns to permit the solid particles to pass. Lastly, in the end view perspective 260, the solid particles are dropping into the auger which turns the particles towards the flow of fluid 226. The auger may have a predetermined number of turns, such as 2, 4, 6, 8, 10, 12 or even more depending on the size of the hard particles. The hole 127 permits the particles to be injected onto the auger and enter the fluid flow 226.

End caps 228 and 229 are used to support the auger 239 and to seal the pressure. This permits for the sleeving of the auger passageway to accommodate larger or smaller augers, and to adjust a wall-to-auger clearance to accommodate different size and types of the various particles. The end caps are not shown in the side view of the mixing block. In the example provided, studs (not shown) were inserted into the block to permit the attachment of the high pressure vessel 110. A large block permits many attachment methods and variances. Turning the auger 239 requires rotary motion. The large block permits for an attachment of a motor to either the block or the end caps for this purpose. The particle feed 227 may just be an opening for the particles to pass through to the fluid stream.

FIG. 2B illustrates an example of the fluid and particle combining channels of the mixer block according to example embodiments. Referring to FIG. 2B, a close-up view 250 of the spool flange 120 is illustrated as a medium for the particles 111 to pass from the high pressure vessel 110 towards the rotating auger 139 inside the mixing block 130. The resulting particle rich fluid 141 passes through the mixing block 130 to an intended destination.

One example embodiment may include the vessel 110 which stores a plurality of hard particles 111 and receives a first flow of fluid from a first fluid interface source 112 that provides the first flow of fluid into the vessel at a first controllable flow rate (i.e., gpm). The configuration may include a mixing block 130 which receives the hard particles, the first flow of fluid and a second flow of fluid 131 from a second fluid interface source that provides the second flow of fluid into the mixing block at a second controllable flow rate. Also, the device may include an output interface 138 which combines the first flow of fluid, the second flow of fluid and the hard particles and provides a combined flow of fluid to an external source. A motor (not shown) connected to the auger causes rotational movement of the auger at a first predetermined rate of rotation, which may be a hydraulic motor. The motor is the easiest way to control the density of hard particles injected into the output mixture. For example, the rotational speed of the auger causes the amount of hard particles to increase or decrease within the mixture output. The number of particles in the fluid is proportional to the rate of rotation of the auger. For example, the faster the auger rotates, the more particles will be ejected from the vessel and into the fluid flow down into the nearby well.

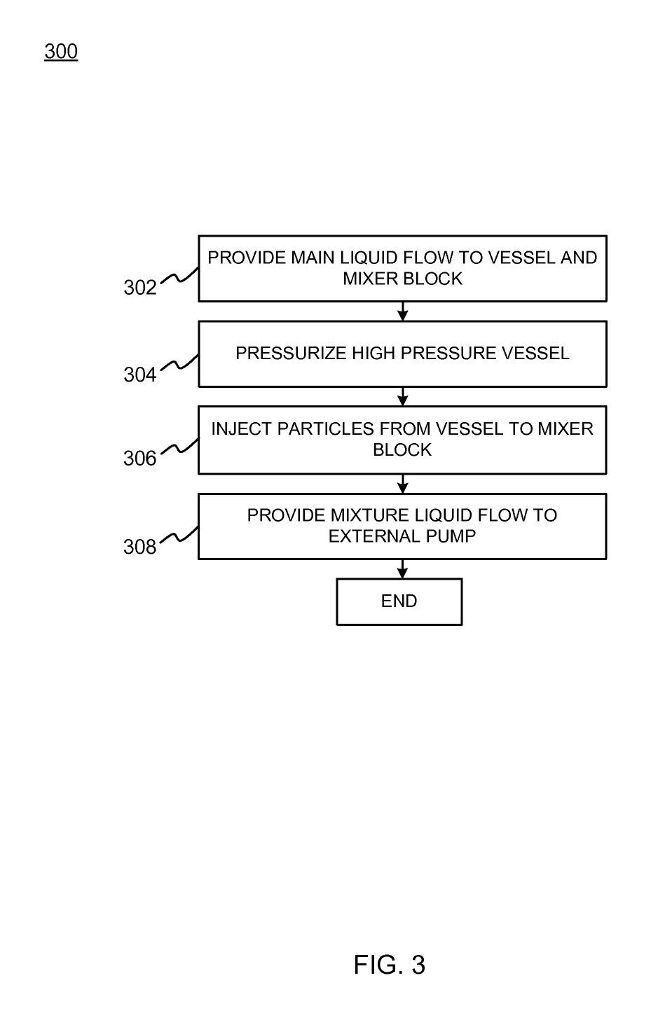

FIG. 3 illustrates a flow diagram of an example method of operation according to example embodiments. Referring to FIG. 3, a basic operation of the device of FIG. 1 may include providing a main fluid flow to the vessel and the mixer block via a different or common source of fluid 302. Generally, the fluid provided is the same fluid but could be different in other embodiments. As the fluid continues to flow, a pressurized degree of pressure will build inside the vessel 304 and as a result of the pressure and the movement of the auger 139, particles can be injected from the vessel to the mixing block 306. Lastly, the mixture created is passed from the mixing block to a desired destination, such as an external output 308. A motor turns the auger 139/239 via any of a hydraulic motor, a gas powered motor, an electric motor, an air or water powered motor, etc. The vessel 110 is pressurized to provide equilibrium with the mining operations. So whatever pressure the corresponding well is currently experiencing (i.e., 500 psi) then the vessel must be set to a comparable pressure to match that particular pressure so the solid particles can be passed into the well and not backwards into the injection system 100 of FIG. 1.

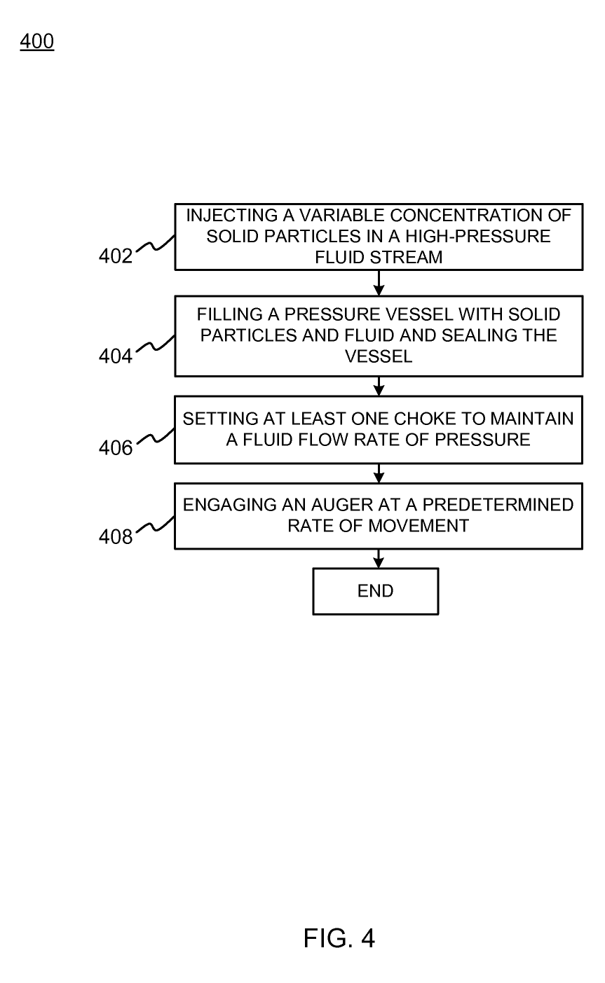

FIG. 4 illustrates another flow diagram of an example method of operation according to example embodiments. Referring to FIG. 4, another example method of operation may include injecting a variable concentration of solid particles into a high-pressure fluid stream to be carried downhole in a hydrocarbon production well 402. An operating cycle may include loading solid particles into a high pressure vessel through an inlet, filling the pressure vessel with fluid and sealing the vessel 404, setting at least one choke to maintain the pressure vessel full of fluid during injection 406, establishing a fluid flow through the various portions of the system, including both the high pressure vessel 110 as well as through the mixing block 130, engaging the auger 139 at a determined rate per minute or gallons per minute (RPM) to move solids into the flow path of the fluid 408.

With regard to fracing technology, certain results have yielded an increase in the production of energy. One experimental technique involves the use of a gel as the fracing fluid, such as a rich viscus type fluid as replacement to sand and with a proppet of a more specific geometric structure (i.e. spheres, cornered cubes, etc.), and the deliberate targeting of the rock formation in the earth to be modified. This approach requires that solid particles 111 of approximately ¼ inch diameter be forced into the hydrocarbon well. Once inside the well, the geothermal heat and pressure from the pressure insertion transforms the particles into a fracing gel and proppet combination. The traditional pumps used for pumping slurry cannot pass such large solids, much less provide the desired solid-to-water concentration.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., parts, alternatives, and minor modifications, etc.) thereto.

What is claimed is:

1. An apparatus comprising:
A vessel which stores a plurality of hard particles and receives a first flow of fluid;
a first fluid interface source that provides the first flow of fluid into the vessel at a first controllable flow rate;
a mixing block which receives the hard particles, the first flow of fluid and a second flow of fluid;
a second fluid interface source that provides the second flow of fluid into the mixing block at a second controllable flow rate; and
an output interface which combines the first flow of fluid, the second flow of fluid and the hard particles and provides a combined flow of fluid to an external source.

2. The apparatus of claim 1, further comprising:
an auger disposed inside the mixing block to rotate the hard particles away from the vessel and into the combined flow of fluid.

3. The apparatus of claim 2, wherein the auger comprises at least four turns.

4. The apparatus of claim 2, wherein the auger comprises at least six turns.

5. The apparatus of claim 2, further comprising:
a motor connected to the auger causing rotational movement of the auger at a first predetermined rate of rotation.

6. The apparatus of claim 5, wherein the motor is a hydraulic motor.

7. A method comprising:
providing a first flow of fluid to a vessel storing a plurality of hard particles at a first controllable flow rate;
ejecting the hard particles into a mixing block which receives the hard particles, the first flow of fluid and a second flow of fluid;
providing the second flow of fluid into the mixing block at a second controllable flow rate; and
combining the first flow of fluid, the second flow of fluid and the hard particles to create a combined flow of fluid provided to an external source.

8. The method of claim 7, further comprising:
rotating an auger disposed inside the mixing block to rotate the hard particles away from the vessel and into the combined flow of fluid.

9. The method of claim 8, wherein the auger comprises at least four turns.

10. The method of claim 9, wherein the auger comprises at least six turns.

11. The method of claim 9, further comprising:
rotating a motor connected to the auger causing rotational movement of the auger at a first predetermined rate of rotation.

12. The method of claim 11, wherein the motor is a hydraulic motor.

13. An apparatus comprising:
A vessel which stores a plurality of hard particles and is pressurized via a fluid injected into the vessel;
a mixing block comprising a channel for the fluid to pass and an auger which rotates inside the mixing block permitting the hard particles to move out of the vessel and into the mixing block; and
an output interface which combines the fluid and the hard particles and provides a combined flow of fluid to an external source.

14. The apparatus of claim 1, further comprising:
a motor connected to the auger causing rotational movement of the auger at a first predetermined rate of rotation.

15. The apparatus of claim 15, wherein the rate of rotation is proportional to the number of particles in the combined flow of fluid.

16. The apparatus of claim 13, wherein the motor comprises one of a hydraulic powered motor, an electric powered motor, a gas powered motor, a fluid powered motor.

17. The apparats of claim 13, wherein a pressure inside the vessel is matched to a pressure inside a well.

18. The apparatus of claim 17, wherein the output interface is connected to a pipe that extends into the well.

19. The apparatus of claim 17, wherein the auger comprises at least eight turns.

20. The apparatus of claim 17, wherein the auger comprises at least twelve turns.
